(19) United States
(12) Patent Application Publication
(10) Pub. No.: US 2019/0098264 A1
(43) Pub. Date: Mar. 28, 2019

(54) Image Intensified Color Camera

(71) Applicant: Irvine Sensors Corporation, Costa Mesa, CA (US)

(72) Inventor: David Ludwig, Irvine, CA (US)

(73) Assignee: Irvine Sensors Corporation, Costa Mesa, CA (US)

(21) Appl. No.: 15/924,519

(22) Filed: Mar. 19, 2018

Related U.S. Application Data
(60) Provisional application No. 62/474,174, filed on Mar. 21, 2017.

(51) Int. Cl. H04N 9/04; H04N 5/225

(52) U.S. Cl. CPC H04N 9/0451; H04N 5/2258; H04N 5/2254

(57) ABSTRACT

An improved image intensified, low light level sensor to enable true color images in real-time from a prior art image intensified, low light level device. The device comprises a Bayer pattern in front of the photocathode element and a CCD or CMOS imager that observes or replaces the phosphor layer of the traditional low light level, intensified imager.

### CROSS-REFERENCE TO RELATED APPLICATIONS

This application claims the benefit of U.S. Provisional Patent Application No. 62/474,174, filed Mar. 21, 2017, entitled “An Image Intensified Color Camera”, pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

### 1. Field of the Invention

The invention relates generally to the field of night vision imaging devices.

More specifically, the invention relates to obtaining true color imagery in very low light conditions in an image intensified, low light level imager device.

### 2. Brief Description of the Prior Art

Typical color cameras degrade in color reproduction as environmental light levels fall. The advantage of conventional color cameras is that their ISO value (electronic gain) can be adjusted from a daylight operation value of ˜100 to a night operation of 1,000,000 or more, i.e.; an electronically-controlled dynamic range of 80 dB without the addition of moving filters. The current state of the art for very high ISO color cameras belongs to the Canon ME20F-SH¹ Video Camera with a maximum ISO of four-million. The cited Cannon camera has a 75 dB electronically-con trolled ISO dynamic range. ¹http://nofilmschool.com/2015/07/canons-multi-purpose-ME20F-SH-full-frame-35 mm-camera-4-million-iso

Image intensified (I²) night vision devices have similar or larger gains than the above Canon video camera. However these devices only output monochrome images, generally either green (or gray scale in white phosphor models) in a direct viewing configuration.

Instead of amplifying electrons within a CMOS amplifier (ISO) for color cameras, an image intensifier amplifies electrons in a micro channel plate under very high voltage. The photons are collected by the night vision device lens and focused onto the “image intensifier tube”. The photons are then converted to electrons at the photocathode. The electrons are accelerated and multiplied by a cascading action in the micro channel plate under high voltage. The electrons are then bombarded onto a phosphor screen at the back of the tube which converts the electrons back to green or white photons. An observer observes the phosphor screen via an eye piece to view the highly amplified image.

Prior art methods of providing full color information day or night involve colorizing monochrome images with color information from a separate source.

The color source may come from the same color camera having a long integration time that captures intermittently and is spaced in the video stream.

The color source may come from the same color camera that captures a single, very long integration time image intermittently spaced in the video stream. This technique is inherently limited by changes in perspective and scene content the change color content between each of the intermittent long integration frames. Similarly, certain prior art infrared image cameras may acquire color information from a high ISO color camera operating at very low frame rates (long integration times). While scene content recognition algorithms cannot be considered to provide the color information in these other methods, pattern recognition is an important signal processing algorithm necessary to provide object color continuity between low frame rate color updates to the real-time monochrome primary sensor.

What is needed is a camera or imaging device that provides real-time color content capture under very low light level conditions without the use of intermittent, very long integration times and/or without the use of other camera reference images that are obtained by very long integration times.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF SUMMARY OF THE INVENTION

The disclosed invention modifies the prior art design approach for image intensified, low light level imager devices which do not produce true color images under low light level conditions. The instant invention adds a novel Bayer filter pattern on the front of the light sensitivity photocathode element and adds a CCD or CMOS imager observing the phosphor screen or substitutes a CCD or CMOS imager for the phosphor screen. Bayer filter pattern outputs on the CCD or CMOS imager are then transformed to true color images. The disclosed invention thus produces true color images under very low light level conditions. The addition of an electrode screen between the photocathode and the micro channel plate enables the true color, low light level camera to operate in day as well as night conditions.

Few if any modifications need to be performed on the existing “image intensifier tube” in the disclosed device. The Bayer filter is the same type filter that is widely used in production-level digital color cameras. The photons striking the photocathode are modulated by the specific color filter directly in front. The “image intensifier tube” still applies gain and the phosphor still emits a green image. However the intensity of the green image is altered by the blue, green and red-colored Bayer filter elements. The monochrome CMOS imager records the intensity images for subsequent color processing.

The color processing step utilizes a similar algorithm that is performed by other color cameras to convert Raw Bayer images into true color images. The only parameters that must be known is which CCD or CMOS pixel corresponds to which Bayer element. In conventional imagers, the Bayer pattern is deposited directly on top of the CCD or CMOS imager. In this invention, the Bayer pattern is deposited on or in front of the photocathode.

### BRIEF DESCRIPTION OF THE SEVERAL VIEWS OF THE DRAWINGS

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

FIG. 1 depicts a block diagram of a prior art night vision monocular sensor which can be modified by the invention to enable a color, low light level imager.

FIG. 2 illustrates how a low light level monocular or other night vision device is converted to a full color imager with the addition of a Bayer pattern filter on or above the photo cathode, along with a monochrome CCD or CMOS imager viewing the phosphor display (or in place of the phosphor display) and Raw-to-MPEG conversion (Bayer-to-true color conversion) in the image processing electronics.

FIG. 3 depicts a CMOS readout device inside the image intensifier tube replacing the typical phosphor screen.

FIG. 4 depicts a micro channel plate electron penetrating the p epitaxial layer in the CMOS pixel and generating electrons which migrate to the n+ diffusion layer to be collected as signal.

### DETAILED DESCRIPTION OF THE INVENTION

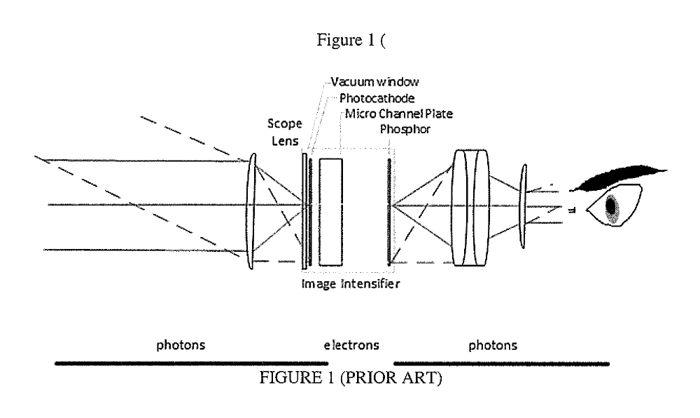

FIG. 1 depicts a block diagram of a prior art night vision monocular sensor which may be modified by the invention to enable a color, low light level imager.

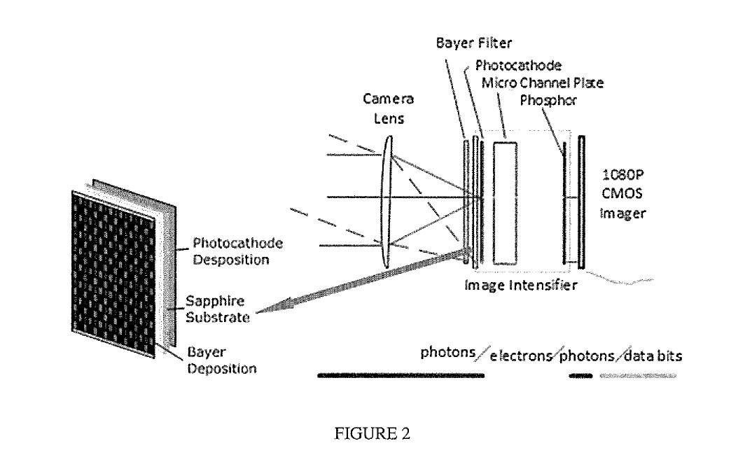

The disclosed invention, illustrated in FIG. 2, modifies the prior art image intensified, low light level imager illustrated in FIG. 1. The prior art image intensified, low light level imager (which, unmodified, does not produce true color images under low light level conditions) is modified in the invention by adding a Bayer filter pattern on the front of the light sensitive photocathode element and by substituting a CCD or CMOS imager for the prior art phosphor screen. The disclosed invention thus produces true color images under very low light level conditions.

The disclosed invention functions when a small number of photons enter the low light level camera optics and are focused on the detectors at various vibration (photon) frequencies that represent the various colors. The photons striking the photocathode are modulated by the specific color filter directly in front. The “image intensifier tube” applies its gain and the phosphor emits its green image. However, the intensity of the green image is altered by the blue, green, and red-colored Bayer filter elements. The monochrome CMOS imager records the intensity images for subsequent color processing.

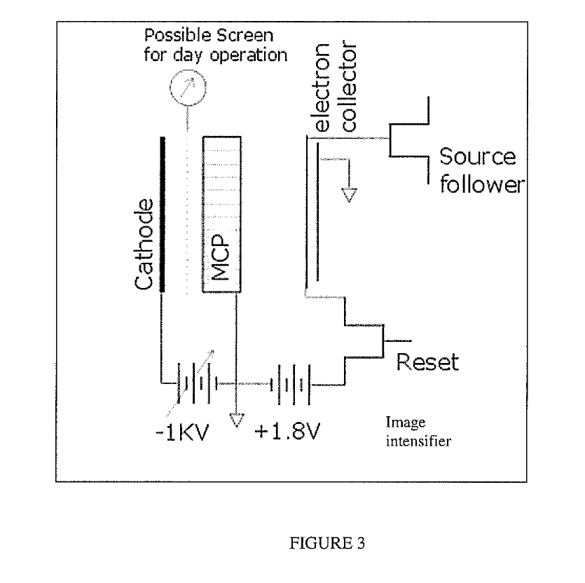

The color processing step utilizes a similar algorithm that is used by other color cameras to convert Raw Bayer images into true color images. The only parameters that must be known in the instant invention are which CCD or CMOS pixel corresponds to which Bayer element. In conventional imagers, the Bayer pattern is deposited directly on top of the CCD or CMOS imager. In the instant invention, the Bayer pattern is deposited on or in front of the photocathode. Further improvement in the number of photons needed for full color reproduction from a low light scene is achieved by substituting the phosphor screen inside the prior art image intensifier (illustrated in FIG. 1) with a direct electron imaging CCD or CMOS imager as illustrated in FIG. 3.

Electrons emitted by the photocathode are amplified by the micro channel plate and attracted to a positively charged capacitor plate in the detector unit cell. The plate loses its charge as the electrons are collected. The plate is reset to a positive voltage at the end of each integration period. The measured light is inversely proportional to the output signal which is corrected in the Bayer-to-true color conversion.

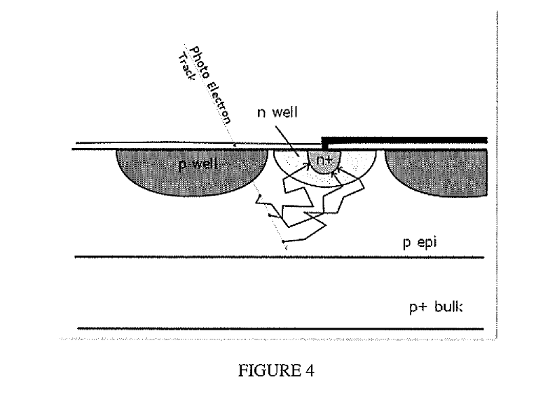

The CCD or CMOS imager is preferably constructed so that electrons are captured by the device and converted into measurable signals. In addition to capturing the electrons on a positively charged capacitor plate, the electrons may be captured directly in the CMOS diode structure itself as illustrated in FIG. 4. The photo-generated electrons from the micro channel plate penetrate the p type epitaxial layer of the diode and generate electron-hole pairs. The electrons drift toward the n-well and then are immediately collected at the n+ terminal as a signal. The signal may be collected on a capacitor or read directly by a source follower MOSFET.

A further improvement to the image intensifier allows the device to operate in day or night conditions by introducing a screen electrode between the photocathode and the micro channel plate. Current night vision devices saturate during the day even as the bias voltage across the micro channel plate is greatly reduced. Such saturation severely limits the lifetime of the device. Auto-shut off is typically incorporated to prevent damage due to normal light level viewing. To permit testing during the day, lens caps with very small holes are fitted over the lens to limit the number of photons entering the device to a level safely below saturation. The incorporation of a screen or grid between the photocathode and micro channel plate with an adjustable voltage level can be used in the invention to limit the number of photons entering the micro channel plate and preventing saturation during daylight operation.

In a typical color camera, the Bayer filter consists of color filters deposited directly on top of the imaging pixel. The filters consist of a pattern of red-green-blue-green or some variation of those same colors, one color per pixel in a repeating pattern over the entire array. There is a direct correspondence between the pixel and its color. In the invention, the Bayer pattern is provided directly or very near the photocathode detector, but is separated from the CCD or CMOS readout pixel. A direct correspondence between filter color and pixel location can be obtained by ensuring appropriate fabrication tolerances or by after fabrication calibration procedures.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and what essentially incorporates the essential idea of the invention.

What is claimed:

1. An apparatus consisting of a low light level camera that produces full true color imagery in real-time without intermittent use of long integrations times or without reference to other sensors observing the same scenes with long integration times by a Bayer pattern placed in front of the photocathode of the image intensifier tube of the traditional low light level imager.

2. The low light level camera of claim 1 may contain a CCD or CMOS imager that observes the phosphor screen of the traditional low light level imager.

3. The low light level camera of claim 1 may contain a CCD or CMOS imager that replaces the phosphor screen of the traditional low light level imager.

4. The low light level camera of claim 1 may contain a processing element that converts the Bayer pattern produced detector responses to true color images.
